(19) United States
(12) Patent Application Publication
(10) Pub. No.: US 2003/0016290 A1
(43) Pub. Date: Jan. 23, 2003

(54) Multi-functional image sensing device

(76) Inventor: Oh-Bong Kwon, Kyoungki-do (KR)

Correspondence Address: MARSHALL, GERSTEIN & BORUN, 6300 SEARS TOWER, 233 SOUTH WACKER, CHICAGO, IL, 60606-6357, US

(21) Appl. No.: 10/197,180

(22) Filed: Jul. 17, 2002

(30) Foreign Application Priority Data
Jul. 18, 2001 (KR) 2001-43062

(51) Int. Cl. H04N 5/225

(52) U.S. Cl. 348/216.1

(57) ABSTRACT

Provided is an image sensing system for receiving a light having a visible ray reflected from the object and for sensing color image or a black and white image of the object, comprising: an infrared ray source for irradiating an infrared ray to the object; an infrared ray source control unit detecting an intensity of a visible ray reflected from the object, and controlling the infrared ray source to be turned on when the intensity of the visible ray reflected from the object is lower than a predetermined level; a light guiding unit for guiding a light reflected from the object; and a color image sensor for receiving the light reflected from the object through the light guiding unit to detect a color image or a black and white image.

### FIELD OF THE INVENTION

The present invention relates to an image sensing system, and, more particularly, to a multi-functional image sensing system that can sense diverse color or black and white images, such as characters, landscape, fingerprints, bar codes, dot codes, and the like, using a color image sensor, formed on a silicon substrate.

### DESCRIPTION OF RELATED ART

As well known, an image sensing system is applied to various fields. For example, an image sensing system is used to observe a motion or still picture of a color or black and white image, such as characters or landscape, or an image sensing system is used to build a database or to interpret stored data by recognizing fingerprints, one- or two-dimensional bar codes, and dot codes.

An image sensor should be designed according to the characteristic of a field the image sensing system is applied to. An image sensor is designed based on the purpose of use as follows, considering which characteristics should be considered significantly.

First, a sensor for sensing a general character or landscape picture requires a color filter for sensing colors, high dynamic range, and high sensitivity.

Second, a fingerprint recognizing sensor should be able to light the bottom side of a fingertip to sense the ridge and valley of a fingerprint, because it is dark when the finger is placed on the sensor. Accordingly, a light source of a regular single wavelength is used, and the image should be made into binary data so as to distinguish the ridge and valley of a fingerprint and recognize the pattern thereof.

Third, in case of a sensor for 1, 2-dimensional bar codes or 1, 2dimensional dot codes, a binary image processing is necessary to recognize the shade pattern using a light source of a regular single wavelength.

Image sensors are classified into two types of sensors: i.e., sensors for sensing colors and sensors for sensing black and white according to the applications. The image sensors are designed and used in accordance with the applications thereof. Accordingly, it takes at least two image sensors to embody an image sensing system that can be used in all fields.

In short, in case where black and white image needs to be provided, an image sensing system including an infrared ray light source 110, an optical lens 120 for receiving light reflecting from an object 200, and an image sensor 130 for sensing the light transmitted from the optical lens 120 and performing signal processing is required as shown in FIG. 1A. In FIG. 1A, the reference numeral ‘131’ denotes a silicon substrate, and ‘132’ denotes an optical sensing and signal processing unit.

In case where a color image needs to be employed, an image sensing system including an optical lens 120 for receiving natural light reflecting from an object 200, and a color image sensor 140 for receiving the light transmitted from the optical lens 120 is required as illustrated in FIG. 1B. In FIG. 1B, the reference numerals ‘141,’ ‘142’ and ‘143’ denote a silicon substrate, optical sensing, and signal processing unit and color filter, respectively.

As shown above, the conventional image system has a shortcoming that a separate image sensor for sensing a black and white image, or a color image, should be equipped to recognize a black or white image, or a color image. Therefore, it is required to develop an image sensing system that can recognize both color and black and white images favorably.

### SUMMARY OF THE INVENTION

It is, therefore, an object of the present invention to provide a multi-functional image sensing system that can be used for both cases where visible ray is provided and where visible ray is not provided, and thereby the multi-functional image sensing system can be used to obtain color and black and white images in an effective manner.

In accordance with an aspect of the present invention, there is provided an image sensing system for receiving a light having a visible ray reflected from the object and for sensing color image or a black and white image of the object, comprising: an infrared ray source for irradiating an infrared ray to the object; an infrared ray source control unit detecting an intensity of a visible ray reflected from the object, and controlling the infrared ray source to be turned on when the intensity of the visible ray reflected from the object is lower than a predetermined level; a light guiding unit for guiding a light reflected from the object; and a color image sensor for receiving the light reflected from the object through the light guiding unit to detect a color image or a black and white image.

### BRIEF DESCRIPTION OF THE DRAWINGS

The above and other objects and features of the present invention will become apparent from the following description of the preferred embodiments given in conjunction with the accompanying drawings, in which:

FIGS. 1A and 1B are schematic diagrams showing a conventional black and white image sensor and a color image sensor, respectively;

FIG. 2 is a schematic diagram illustrating an image sensing system in accordance with an embodiment of the present invention;

FIG. 3 is a graph showing the absorption of a silicon material based on the wavelength of light;

FIG. 4 is a graph describing the characteristic of an infrared ray filter that transmits visible ray in a particular wavelength range;

FIG. 5 is a graph showing the optical transmittance of a color filter based on wavelength;

FIGS. 6A and 6B are schematic diagrams depicting the image sensing system in accordance with the present invention; and

FIG. 7 is a graph showing the characteristic of an infrared ray filter that blocks infrared ray of a particular wavelength range.

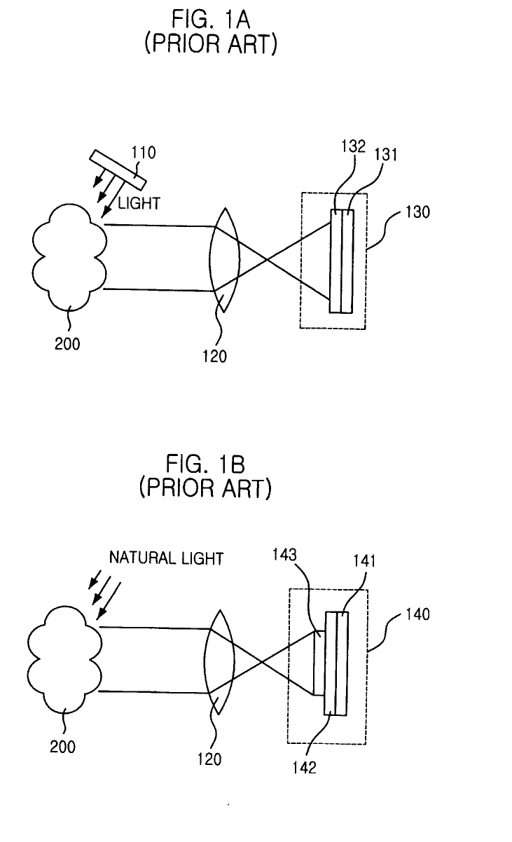

### DETAILED DESCRIPTION OF THE INVENTION

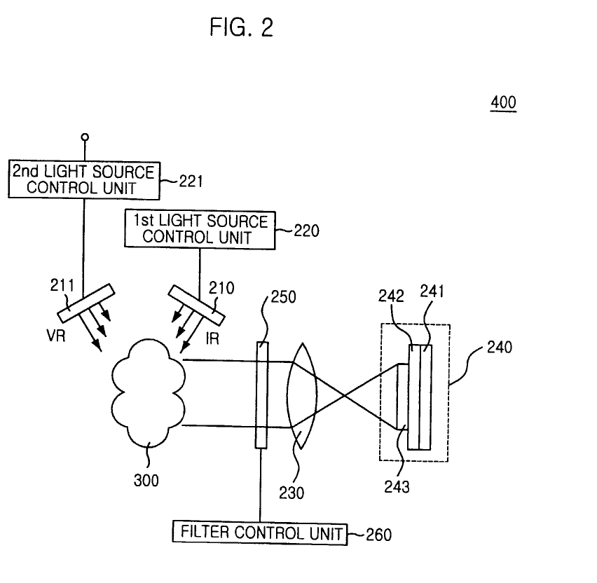

Referring to FIG. 2, therein shown an image sensing system in accordance with an embodiment of the present invention. The image sensing system 400 includes an infrared ray source 210, an infrared ray source control unit(a first light source control unit) 220, a light guiding unit 230, a color image sensor 240. The image sensing system 400 further includes a visible ray source 211, and a visible ray source control unit(a second light source control unit) 211. And the image sensing system 400 further includes a filtering unit 250 and a filter control unit 260.

The infrared ray source 210 irradiates infrared ray (IR) to an object 300. The infrared ray source control unit 220 controls the infrared ray source 210 to be turned on/off. The light guiding unit 230 is formed of an optical lens and receives light reflected from the object 300. The color image sensor 240 receives the light transmitted from the light guiding unit 230 to detect a color image or a black and white image. The filtering unit 250 transmits the light in the wavelength range of visible ray, and blocks the light in the wavelength of infrared ray. The filter control unit 260 controls the filtering unit to be activated. The visible ray source 211 irradiates a visible ray to the object 300, and a visible ray source control unit 221 controls the visible ray source 211 to be turned on/off according to an input signal transmitted thereto. The color image sensor 240 includes an optical sensing and signal processing device 242 and a color filter 243 formed on the silicon substrate 241.

Since the color image sensor 240, formed on a silicon substrate 241, better absorbs the light in the range of 700˜800 nm, it is desirable to use a light-emitting diode that emits white light or monochromatic light in a certain wavelength range, that is, 700˜800 nm, as the infrared ray light source 210.

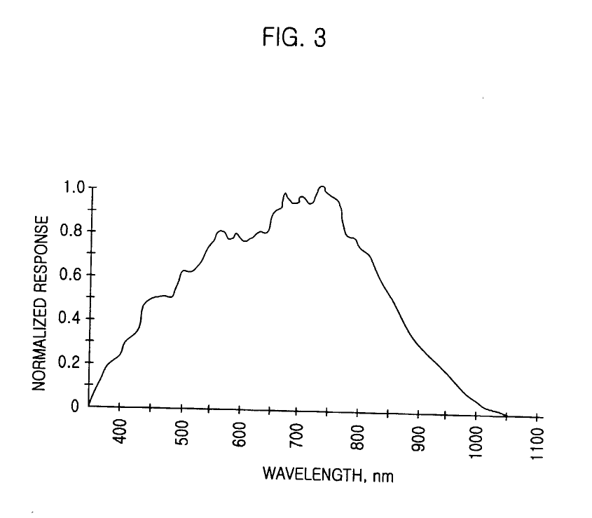

FIG. 3, there is shown a graph describing the absorption of a silicon material based on the wavelength of light, which shows a maximum absorption light in the range of 700˜800 nm. The filtering unit 250 can be employed with a conventional infrared ray filter or an optical low pass filter, and the filtering unit 250 can be placed anywhere before or behind the light guiding unit 230.

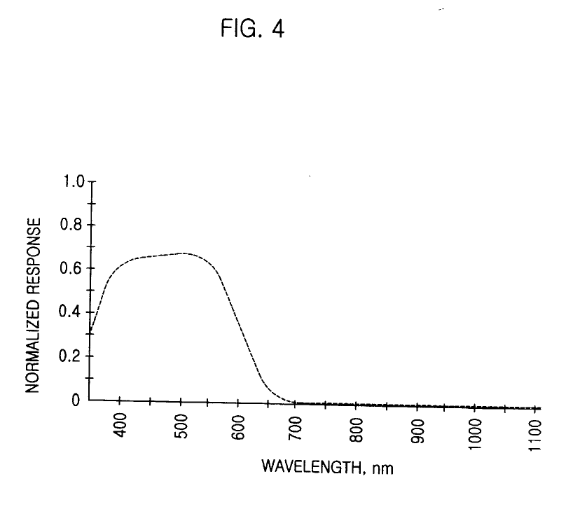

FIG. 4 is a graph describing the characteristic of an infrared ray filter that transmits visible ray in the wavelength range of 300˜700 nm, shows that the light in the wavelength range of more than 700 nm is blocked by the infrared ray filter. The infrared ray filter or optical low pass filter is used to enhance the sensitivity of a sensor by transmitting visible ray of smaller than 700 nm, which can be sensed by human beings.

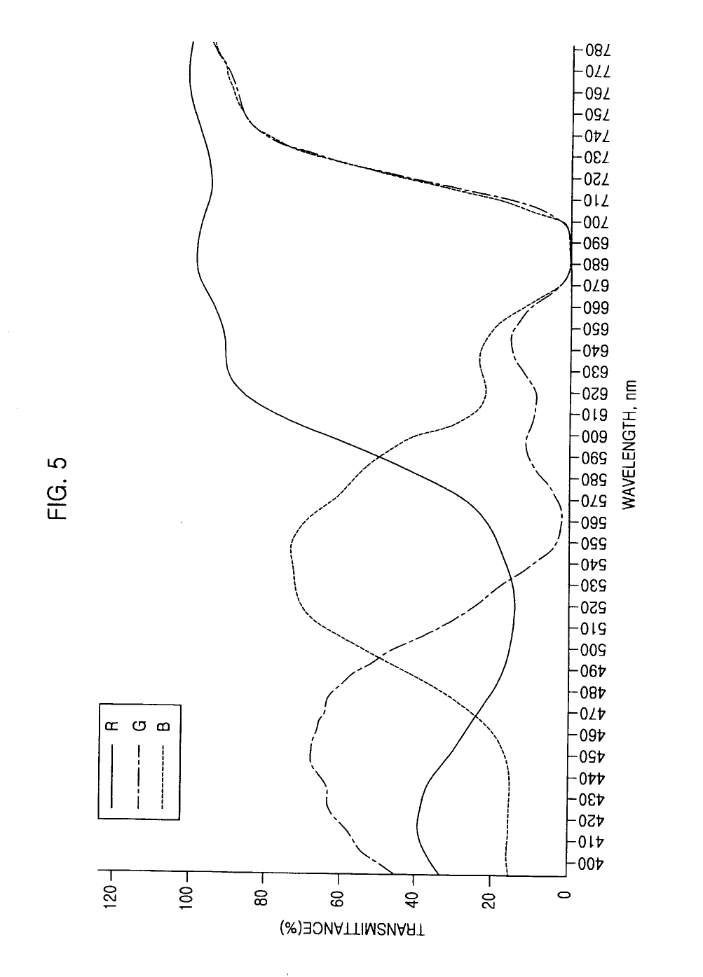

FIG. 5 is a graph showing the optical transmittance of each red (R), green (G), and blue (B) color filter depending on wavelength. The infrared ray and the visible ray source control units 220, 221 can be embodied to turn on/off the infrared ray source 210 and the visible ray source 211 electrically or mechanically. The filter control unit 260, also, controls the activation of the filtering unit 250 electrically or mechanically so that the filtering unit 250 is activated.

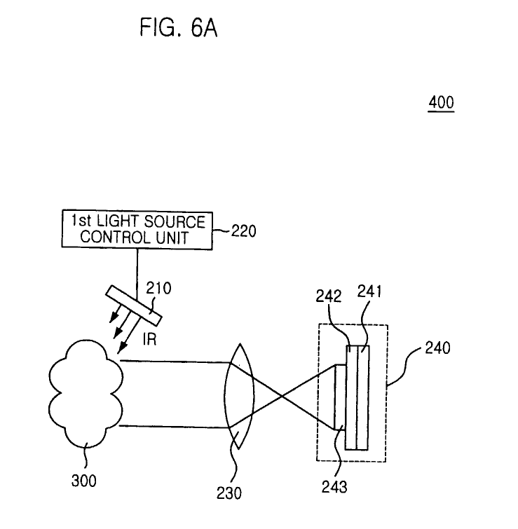

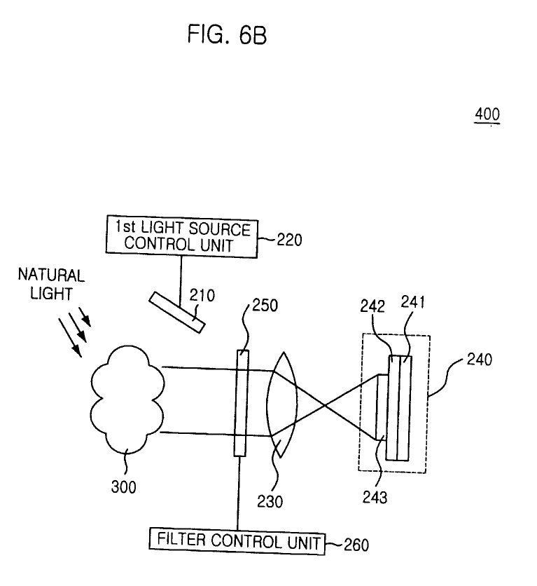

FIGS. 6A and 6B are diagrams depicting the operations of the light source control unit 220 and the filter control unit 260 according to the characteristics of a field to which the image sensing system of the present invention is applied. Referring to FIG. 6A, an example where a black and white image is obtained using the image sensing system of the present invention will be described herein. Here, since an intensity of a light reflected from an object 300 is lower than a predetermined level, for instance, the intensity of the light reflected from the object 300 is lower than a value between 5˜20 lux, the infrared ray source control unit 220 turns on the infrared ray source 210 that supplies infrared ray and irradiate the infrared ray to the object 300. As shown in this example, when the infrared ray source 201 is turned on alone, the filtering unit is inactivated or moved by a filter controlling unit. An image sensor 240 receives the infrared ray, which has reflected from the object 300 and transmitted a light guiding unit 230, and detects a black and white image. The filtering unit and the filter control unit are not illustrated in FIG. 6A.

As shown above, when the infrared ray source 210 that supplies infrared ray is turned on alone, the filtering unit is inactivated or moved by the filter control unit 260 and the infrared ray source 210 is controlled to be turned on by the infrared ray source control unit 220. When the image sensing system in accordance with the present invention is applied to a field where color embodiment is not needed, that is, a black and white or monochromic image which needs to distinguish the shade, such as characters and landscape, fingerprint recognition, 1, 2-dimensional bar codes, and 1, 2-dimensional dot codes, as illustrated in FIG. 6A, the filtering unit should be inactivated or removed, and the infrared ray source 210 should be turned on. The infrared ray light of 700˜800 nm radiated from the infrared ray source 210 is reflected from the object 300, is by-passed through the light guiding unit 230, and is transmitted to the color image sensor 240. Since the infrared ray in the 800 nm wavelength range is absorbed in a silicon material very well, the light reacts sensitively in the color image sensor 240, which is a silicon device. Therefore, it is possible to embody a shade image with high resolution. In addition, as described in FIG. 5, because the infrared ray of 700˜800 nm has excellent optical transmittance in the RGB color filter, too, a shade image with high resolution can be embodied.

Accordingly, the shapes of objects or people can be sensed clearly in a dark place, such as a movie theatre, by using the image sensing system of the present invention, which is set as shown in FIG. 6A by the infrared ray source control unit 220 and the filter control unit 260. This image sensing system can be used for recognizing fingerprint, bar codes, or dot codes very usefully.

Following are two examples, in which a color image is obtained using the image sensing system of the present invention. In one example, since an intensity of a light reflected from an object is lower than a predetermined level, for instance, between 5˜20 lux, an infrared ray source control unit turns on the infrared ray source that supplies infrared ray, and when the intensity of the light reflected from the object is higher than the predetermined level, the infrared ray source control unit turns off the infrared ray source supplying infrared ray. When the intensity of the light reflected from the object is lower than the predetermined level and a color image is still required, a visible ray source control unit is operated according to an input signal by the system operator to turn on the visible, ray source, and thus a visible ray is irradiated from the visible ray source to the object. As shown in this example, the filter control unit aligns or activates the filtering unit, in both cases when the visible ray is not irradiated from the visible ray source because the intensity of the light reflected from the object is higher than the predetermined level, and when the visible ray is irradiated from the visible ray source because the intensity of the light reflected from the object is lower than the predetermined level. An image sensor receives the visible ray that has reflected from the object and transmitted the light guiding unit and the filtering unit, and detects a color image.

FIG. 6B shows the other example of obtaining a color image. In this example, natural light is irradiated to the object 300 without any infrared ray and/or a visible ray supplied from the infrared ray source and/or the visible ray source. That is, an intensity of the light reflected from an object 300 is higher than the predetermined level, the infrared ray and the visible ray sources 210, 211 are turned off, and the filtering unit 250 is activated or aligned by a filter control unit 260. In this manner, the shade and color information of the object can be obtained from the natural light reflecting from the object 300. That is, when the image sensing system in accordance with the present invention is applied to color image sensing of a character, animal, landscape or other objects, the filtering unit 250 should be aligned as illustrated in FIG. 6B, and shade and color information of the object should be obtained from the natural light to embody the image.

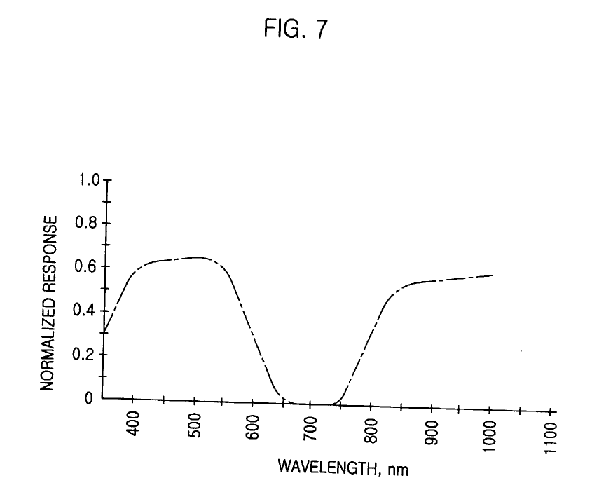

In the meantime, generally, it is possible to embody an infrared ray filter of FIG. 7, which transmits visible ray of under 650 nm, blocks infrared ray in the wavelength range of 750 nm, and transmits infrared ray more than 750 nm. In short, it is possible to embody an infrared ray filter to filter the infrared ray in a particular wavelength range. Accordingly, if the infrared ray filter described in FIG. 7 is applied to the filtering unit 250 and a light-emitting diode, which emits a white light or a monochromic light in a particular wavelength of 750˜800 nm is used as infrared ray light source 210, the control unit 260 of the filtering unit 250 would not be needed. In other words, if the wavelength of the infrared ray light source 210 and the blocking wavelength range of the infrared ray filter are set properly, it does not matter whether the filtering unit 250 for filtering infrared ray is activated or inactivated, in any case, i.e., color image sensing, or black and white or monochromic image sensing. The infrared ray filter that blocks infrared ray in a particular wavelength range can be embodied as a film coated on the light guiding unit, such as an optical lens.

The image sensing system of the present invention is economical because it can be used for both cases where visible ray is provided and where visible ray is not provided. Accordingly, it is possible to obtain color and black and white or monochromic image by using one color image sensor. Images processed in this image sensing system have a high resolution and sensitivity.

While the present invention has been described with respect to certain preferred embodiments, it will be apparent to those skilled in the art that various changes and modifications can be made without departing from the scope of the invention as defined in the following claims.

What is claimed is:

1. An image sensing system for receiving a light having a visible ray reflected from the object and for sensing color image or a black and white image of the object, comprising:
an infrared ray source for irradiating an infrared ray to the object;
an infrared ray source control unit detecting an intensity of a visible ray reflected from the object, and controlling the infrared ray source to be turned on when the intensity of the visible ray reflected from the object is lower than a predetermined level;
a light guiding unit for guiding a light reflected from the object; and
a color image sensor for receiving the light reflected from the object through the light guiding unit to detect a color image or a black and white image.

2. The image sensing system as recited in claim 1, further comprises a filtering unit for by-passing a visible ray and blocking an infrared ray reflected from the object; and
a filter control unit for activating the filtering unit when the intensity of the visible ray reflected from the object is higher than the predetermined level.

3. The image sensing system as recited in claim 1, wherein the infrared ray source control unit controls the infrared ray source to be turned off when the intensity of the visible ray reflected from the object is higher than the predetermined level.

4. The image sensing system as recited in claim 1, wherein the infrared source is a white or monochromic light-emitting diode.

5. The image sensing system as recited in claim 1, further comprises a visible ray source for irradiating a third visible ray to the object; and
a visible ray source control unit for controlling the visible ray source to be turned on/off according to an input signal transmitted thereto.

6. The image sensing system as recited in claim 1, wherein the color image sensor is formed on a silicon substrate.

7. The image sensing system as recited in claim 1, wherein the color image sensor includes a three color filter, the three colors being red, green, and blue.

8. The image sensing system as recited in claim 3, wherein the filtering unit is aligned before or behind the guiding unit.

9. The image sensing system as recited in claim 1, wherein the light guiding unit is an optical lens.

10. The image sensing system as recited in claim 1, wherein the infrared ray source control unit controls the light source to be turned on/off electrically or mechanically.

11. The image sensing system as recited in claim 3, wherein the filter control unit controls the activation of the filtering unit electrically or mechanically.
